(19) United States
(12) Patent Application Publication
(10) Pub. No.: US 2007/0150311 A1
(43) Pub. Date: Jun. 28, 2007

(54) System for exchanging patient medical information between different healthcare facilities

(76) Inventor: A. Ann Lazerus, Bountiful, UT (US)

Correspondence Address: Siemens Corporation;Intellectual Property Department, 170 Wood Avenue South, Iselin, NJ, 08830, US

(21) Appl. No.: 11/401,154

(22) Filed: Apr. 10, 2006

Related U.S. Application Data
(60) Provisional application No. 60/682,553, filed on May 19, 2005.

(51) Int. Cl. G06Q 10/00; G06F 19/00

(52) U.S. Cl. 705/2; 705/3

(57) ABSTRACT

A Patient Information Sharing and Transfer System provides a system for moving patient information and clinical data between healthcare facilities using predictive capability across an enterprise or groups of patient health care facilities. A system for exchanging patient medical information between different healthcare facilities comprises a monitor for monitoring activities of individual patients to determine if an event occurs indicating an individual patient is likely to receive services at a second healthcare facility and to initiate forwarding of medical information of the individual patient to the second healthcare facility from a first healthcare facility. A data processor formats medical information of the individual patient into a common format employed by the different healthcare facilities for exchanging patient medical information, in response to occurrence of an event detected by the monitor. A communication processor initiates communication of the medical information of the individual patient in the common format to the second healthcare facility.

This is a non-provisional application of provisional application Ser. No. 60/682,553 by A. Lazerus filed May 19, 2005.

### FIELD OF THE INVENTION

This invention concerns a system for exchanging patient medical information between different healthcare facilities supporting the treatment of a patient at the different healthcare facilities.

### BACKGROUND INFORMATION

It is commonly required that a patient receives treatment related services at multiple different healthcare facilities (e.g., clinic and radiology facilities) in the course of providing healthcare to the patient. When a patient is scheduled to receive a service at a different facility or appears at another facility for services, patient information is acquired from the patient for each encounter. This results in duplicate data entry, more chances for data entry errors and incomplete information being provided to a healthcare facility. Existing systems attempt to address this problem by establishing a common master patient index that is accessible to both facilities and used as a common location for patient demographic information. Such an existing implementation requires that each facility agree on the common elements of the index and establish a common encoding scheme or rules. This implementation requires sharing of large amounts of information that may be used by just one healthcare facility and also requires substantial investment in hardware, software and infrastructure. This implementation also presents security and confidentiality problems in processing patient information with each facility typically desiring to be in sole control of their patient healthcare data.

Existing systems typically require that clinical information is hand carried by a patient from one healthcare facility to the next and also involves duplicate laboratory tests and diagnostic tests as well as possible longer length of hospital stay and the incurrence of other related expenses. Further, existing systems involving manual patient record transfer are not consistently implemented across healthcare providers and facilities and is labor intensive. Existing systems involve redundant burdensome, duplicative data processing and increased use of computer processor resources and memory. A system according to invention principles addresses these deficiencies and related problems.

### SUMMARY OF THE INVENTION

A system routes patient data directly to or from one healthcare facility to another facility either by direct user interface or by using a predictive routing subsystem allowing an enterprise to maintain a single medical record number for a patient across the enterprise without the use of an EMPI (electronic master patient index). The system reduces redundant data processing, use of processor resources and memory. A system for exchanging patient medical information between different healthcare facilities comprises a monitor for monitoring activities of individual patients to determine if an event occurs indicating an individual patient is likely to receive services at a second healthcare facility and to initiate forwarding of medical information of the individual patient to the second healthcare facility from a first healthcare facility. A data processor formats medical information of the individual patient into a common format employed by the different healthcare facilities for exchanging patient medical information, in response to occurrence of an event detected by the monitor. A communication processor initiates communication of the medical information of the individual patient in the common format to the second healthcare facility.

### BRIEF DESCRIPTION OF THE DRAWING

FIG. 1 shows a system for exchanging patient medical information between different healthcare facilities, according to invention principles.

FIG. 2 shows a flowchart of a process used in exchanging patient medical information between different healthcare facilities, according to invention principles.

FIG. 3 shows a flowchart of a process employed by a healthcare facility for receiving and processing medical information of an individual patient in a common format from one or more different healthcare facilities, according to invention principles.

### DETAILED DESCRIPTION OF INVENTION

The management of patient information as patients move from a first healthcare facility employing a first hospital information system (HIS) to a different second healthcare facility employing a different second hospital information system results in additional overhead to the different facilities. A system routes patient data directly from one healthcare facility to another facility either by direct user interface or by using a predictive routing subsystem. The system advantageously allows an enterprise to maintain a single medical record number for a patient across an enterprise, or different organizations involving multiple different healthcare facilities without the use of an EMPI (electronic master patient index). The system improves operation of computer processing in a HIS by reducing redundant data processing, reducing use of processor resources and reducing required memory.

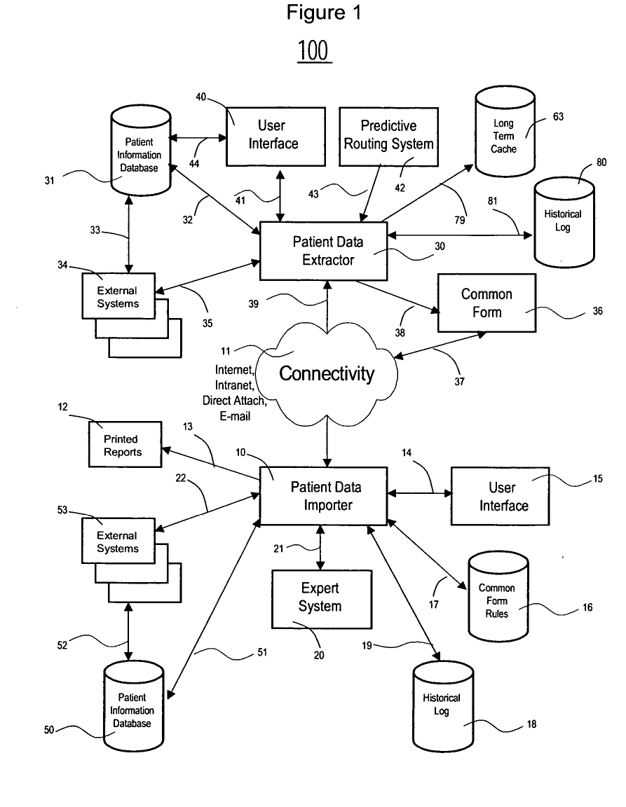

FIG. 1 shows system 100 for exchanging patient medical information between different healthcare facilities. System 100 provides a lower cost alternative (relative to use of a master patient index, for example) for sharing data among facilities with both manual and predictive routing capabilities. System 100 allows a healthcare facility to share data with an approved list of other facilities while retaining control of the destination, content and security of the data. An individual healthcare facility may decide what data is to be shared, how it is to be shared and maintains control of its own data during sharing. System 100 enables a user to establish (e.g., configure) particular rules to be used in processing patient data received from a particular source system in order to address the security, control and content requirements of a facility receiving the patient data. Patient care is improved because the patient related information is available at both the receiving facility and a source system sending facility.

An executable application as used herein comprises code or machine readable instruction for implementing predetermined functions including those of an operating system, healthcare information system or other information processing system, for example, in response user command or input. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device. An object or data object as used herein comprises a grouping of data, executable instructions or a combination of both or an executable procedure. A document or record comprises a compilation of data in electronic or paper form.

System 100 (FIG. 1) exchanges patient medical information between different healthcare facilities using Patient Data Extractor (PDE) 30. Execution of PDE 30 is initiated either via user interface 40 through bidirectional communication link 41 or via Predictive Routing System 42 through bidirectional communication link 43. A user enters information via user interface 40 to uniquely identify a patient. The patient identifying information consists of one or more of, Social Security Number, governmental issued medical identification, encounter or account number, name and birthdate, person identification number or Medical Record Number (MRN), for example. User interface 40 employs the user entered patient identification information in initiating a search of patient information database 31 through bidirectional communication link 44. User interface 40 provides a patient selection verification display image presenting search results indicating one or more records associating the patient identifying information with patient encounters (e.g., patient visits, phone calls, record accesses, treatment activities). A user examines the presented search results in order to verify a patient indicated is the correct patient or to select a particular patient from records of multiple different candidate patients. If the search results reveal that the patient identifying information is associated with a record identifying a single patient encounter, the patient selection verification display image is pre-configured to be omitted. In another embodiment, the patient selection verification display image is displayed under this condition.

A user enters data identifying a destination to which patient medical records are to be sent via user interface 40. User interface 40 provides one or more user navigable menus enabling searching candidate destinations and selecting a particular destination or enabling user entry of a destination code, indicating a location to where patient data is to be sent. User interface 40 communicates data indicating the results of the destination selection and verified particular patient identification information to PDE 30 through bidirectional communication link 41. PDE 30 receives the data indicating the destination selection and verified patient identification information and locates the patient information in Patient Information Database 31 through bidirectional communication link 32. PDE 30 also accesses information such as additional medical records of a verified selected particular patient from external systems 34 through bidirectional communication link 35. External systems also bidirectionally communicate with patient information database 31 via communication link 33 for accessing and storing patient information including clinical and financial information, for example.

In response to PDE 30 receiving a request for patient information through communication link 41 or from predictive routing system 42 through bidirectional communication link 43, a record comprising a historical log of the request is placed into Historical Log 80 through bidirectional communication link 81. The record indicates the nature of the request, the type of information requested, the identity of the requestor, a predictive system identifier, the identity of the requesting computer system, the status of the request including whether it failed or succeeded and the identity of any destination system for receiving the requested information if different from the requesting computer system. In response to the information request, PDE 30 incorporates the requested patient information into common form 36 through communication link 38.

In response to the requested patient information being incorporated into common form 36, data representing common form 36 together with the incorporated information is routed to the selected healthcare facility destination via network 11. Network 11 employs any type of protocol or data format including direct connectivity or e-mail. The protocol or data format includes, but is not limited to, one or more of the following: an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, a Campus Area Network (CAN) protocol, a Metropolitan Area Network (MAN) protocol, a Home Area Network (HAN) protocol, an Institute Of Electrical And Electronic Engineers (IEEE) bus compatible protocol, a Digital and Imaging Communications (DICOM) protocol, and a Health Level Seven (HL7) protocol. The patient information in common form 36 is communicated through interface 37 and network 11 to a Patient Data Importer (PDI) 10 of a destination receiving healthcare facility (or facilities).

Data indicating activities performed by PDI (10) is recorded in Historical Log 18 through interface 19. Data is recorded in Historical Log 18 to satisfy legal requirements such as the Healthcare Information Portability and Accountability Act (HIPAA), internal hospital auditing requirements or for troubleshooting an executable application. In response to the patient information in common form 36 being received by PDI 10 of a destination receiving healthcare facility, PDI 10 uses common form rules 16 acquired via interface 17 to transform the received data to a data format required by a receiving system of the destination healthcare facility. The transformed patient information is stored in Patient Information Database 50 via interface 51.

PDI 10 in one embodiment sends the transformed patient information to one or more External Systems 53 through communication link 22 if required. One or more External Systems 53 may optionally provide information to Patient Information Database 50 through communication link 52. PDI 10 in one embodiment employs Expert System 20 (e.g. an executable application) accessed through interface 21 to transform complex patient data that cannot be accomplished by PDI 10 using Common Form Rules 16. A user configures operation of PDI 10 via user interface 15 through bidirectional communication link 14. Expert system 20 is employed to extend Common Form Rules 16 by providing additional specialized rules needed for data transformation or data routing.

Predictive Routing System (PRS) 42 automatically monitors patient related scheduling and Admission Discharge and Transfer (ADT) activities to determine if a patient data transfer and scheduled appointment at a different healthcare facility is to occur. PRS 42 monitors patient appointments, healthcare worker schedules, resource schedules and appointment and scheduling messages and transactions in predicting and initiating forwarding of patient information to a healthcare facility. If a patient is scheduled for an appointment at a particular healthcare facility, a query is automatically communicated by PRS 42 to multiple different healthcare facilities of an enterprise or to facilities associated with different organizations to determine if a patient has been seen at any other facilities. An individual healthcare facility, that has a record identifying an encounter of the patient concerned with the individual healthcare facility, sends information identifying the encounter to PRS 42. If the patient is transferred to another healthcare facility, PRS 42 forwards the current encounter information to a receiving healthcare facility through the PDE 30 through bidirectional communication link 43. PRS 42 also sends a query to other healthcare facilities in an enterprise or associated with other organizations requesting additional information to be sent to a receiving healthcare facility scheduled for a patient encounter.

If a patient visits an Emergency Room of a hospital, diagnosis, orders and medications are reviewed and if the rules indicate, the patient information is sent to a next probable location for the next level of care for the patient. For example, based on patient activities, treatment and condition, PRS 42 determines patient transfer to a cardiac specialty care hospital is likely. Consequently, PRS 42 initiates forwarding of associated patient information to the cardiac specialty hospital.

A healthcare facility may be designated through user entered configuration information as a “home facility” for a patient. Data indicating medical changes related to a patient is automatically communicated to a home facility if the patient has received services at any of the healthcare facilities of an enterprise or other organizations. PRS 42 optionally designates a home facility for an individual patient based on rules related to a home address and visit patterns of a patient. As patient visit patterns change, Predictive Routing System 42 automatically changes the designation of a home facility to a new patient visit location. PRS 42 may use primary care provider insurance information, obtained directly from the carrier to designate a home facility for the patient. Predictive Routing System 42 optionally provides long term caching of patient and configuration information in unit 63 via PDE 30 and interface 79 based on specific selection criteria. The cached data is usable for research, clinical usage patterns, or financial analysis as required. PRS 42 may use consumer outreach functions and data such as self-service preadmission functions and data to initiate communication of information about a patient to a pre-admission facility so that historical data is present when the patient arrives at a healthcare facility.

System 100 advantageously employs PRS 42 to initiate forwarding of patient data to a healthcare facility in response to monitoring activities concerning an individual patient. System 100 also employs common rules to build patient information in a common form and to use the rules to extract patient data at a receiving healthcare facility. Expert system 20 enables supplementing of the common rules and unit 12 enables printing of reports via interface 13 that provide information about the activities of PDI 10 and PDE 30. The system may be used in multi-entity health care enterprises or communities with shared patient data agreements.

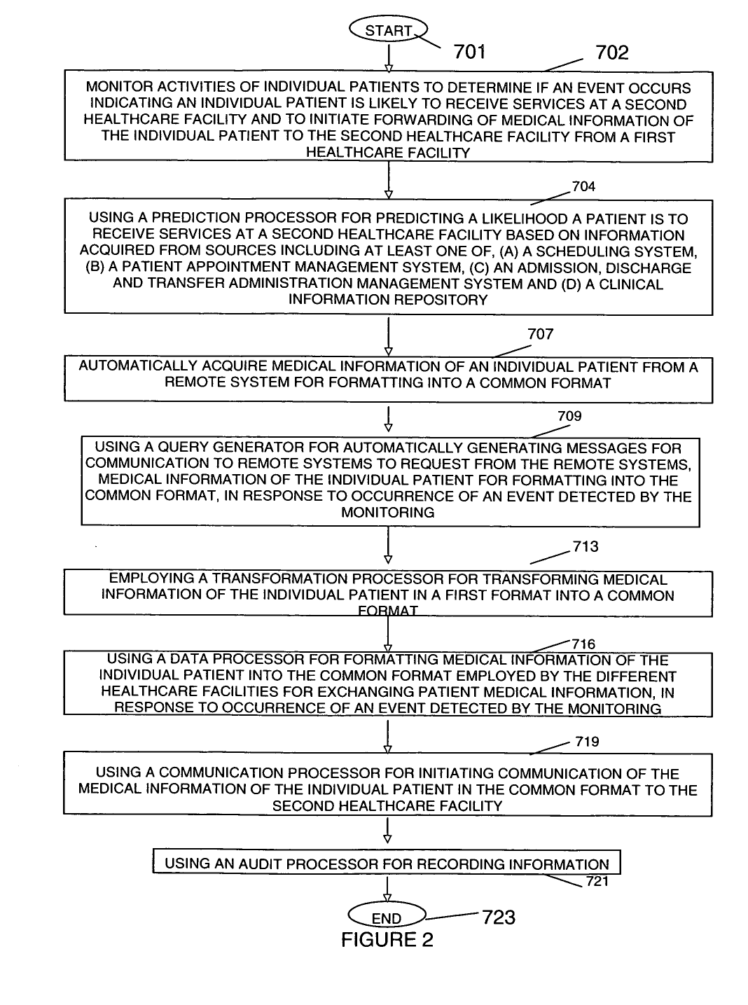

FIG. 2 shows a flowchart of a process used by system 100 in automatically exchanging patient medical information between different healthcare facilities. In step 702 following the start at step 701, system 100 monitors activities of individual patients to determine if an event occurs indicating an individual patient is likely to receive services at a second healthcare facility and to initiate forwarding of medical information of the individual patient to the second healthcare facility from a first healthcare facility. The determination the event occurs comprises detection of data indicating the individual patient is in an emergency department, for example. The determination the event occurs may also comprise detection of data indicating the individual patient is, scheduled to receive healthcare services at the second healthcare facility, scheduled for an appointment at the second healthcare facility, admitted to the second healthcare facility or transferred to the second healthcare facility. System 100 monitors activities of an individual patient selected in response to user entered patient identification information. The user entered patient identification information includes one or more of, social security number, name, medical record number, patient identifier, encounter or account number, birth date and a government issued patient identification number.

A prediction processor in system 100 in step 704 predicts a likelihood a patient is to receive services at a second healthcare facility based on information acquired from sources including at least one of, (a) a scheduling system, (b) a patient appointment management system, (c) an admission, discharge and transfer administration management system and (d) a clinical information repository. The prediction processor predicts information comprising an identity and location of the second healthcare facility where the individual patient is to receive further healthcare. The prediction processor predicts identity and location of the second healthcare facility in response to, a patient diagnosis, a patient medical condition assessment, data indicating a current healthcare treatment being received by the individual patient or data indicating a current location where healthcare treatment is being received by the individual patient.

In step 707 an acquisition processor in system 100 automatically acquires medical information of the individual patient from a remote system for formatting into a common format. In step 709 a query generator in system 100 automatically generates messages for communication to remote systems to request that the remote systems communicate medical information of the individual patient to the second healthcare facility in the common format. The messages may alternatively request medical information of the individual patient for formatting by system 100 into the common format for communication to the second healthcare facility. A transformation processor in system 100 in step 713 transforms medical information of the individual patient in a first format into the common format.

In step 716 a data processor in system 100 formats medical information of the individual patient into a common format employed by the different healthcare facilities for exchanging patient medical information, in response to occurrence of an event detected by the monitor in system 100. In step 719 a communication processor in system 100 uses the predicted information in communicating the medical information of the individual patient in the common format to the second healthcare facility at a destination identified using user entered information. An audit processor in system 100 in step 721 records information identifying, a destination of the communicated medical information of the individual patient, a user authorizing or initiating communication of the medical information of the individual patient and a workstation used for authorizing communication of the medical information of the individual patient. The process of FIG. 2 terminates at step 723.

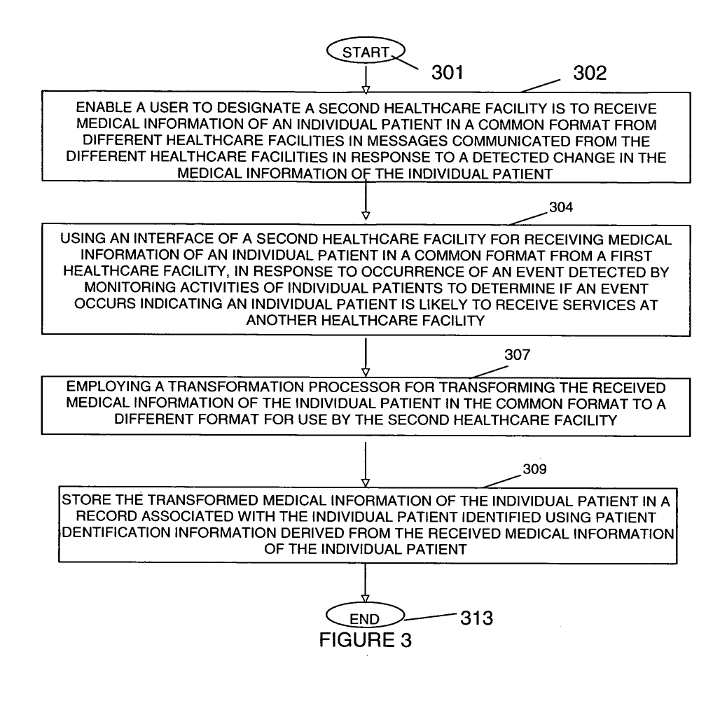

FIG. 3 shows a flowchart of a process employed by a healthcare facility for receiving and processing medical information of an individual patient in a common format from one or more different healthcare facilities. In step 302 following the start at step 301, a configuration processor in system 100 enables a user to designate a second healthcare facility to receive medical information of an individual patient in a common format from different healthcare facilities in messages communicated from the different healthcare facilities in response to a detected change in the medical information of the individual patient. In step 304, an interface of a second healthcare facility in system 100 receives medical information of an individual patient in a common format from a first healthcare facility. This occurs in response to an event detected by monitoring activities of individual patients to determine if an event happens indicating an individual patient is likely to receive services at another healthcare facility. The common format is employed by the different healthcare facilities for exchanging patient medical information.

In step 307, a transformation processor in system 100 transforms the received medical information of the individual patient in the common format to a different format for use by the second healthcare facility. A storage processor in system 100 in step 309 stores transformed medical information of the individual patient in a record associated with the individual patient identified using patient identification information derived from the received medical information of the individual patient. The process of FIG. 3 terminates at step 313.

The system and processes of FIGS. 1-3 presented herein are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the system and process of FIGS. 1-3, may be implemented in hardware, software or a combination of both.

What is claimed is:

1. A system for exchanging patient medical information between different healthcare facilities, comprising:
a monitor for monitoring activities of individual patients to determine if an event occurs indicating an individual patient is likely to receive services at a second healthcare facility and to initiate forwarding of medical information of said individual patient to said second healthcare facility from a first healthcare facility;
a data processor for formatting medical information of said individual patient into a common format employed by said different healthcare facilities for exchanging patient medical information, in response to occurrence of an event detected by said monitor; and
a communication processor for initiating communication of said medical information of said individual patient in said common format to said second healthcare facility.

2. A system according to claim 1, including
a prediction processor for predicting a likelihood a patient is to receive services at a second healthcare facility based on information acquired from sources including at least one of, (a) a scheduling system, (b) a patient appointment management system, (c) an admission, discharge and transfer administration management system and (d) a clinical information repository.

3. A system according to claim 1, including
a prediction processor for predicting information comprising an identity and location of said second healthcare facility and
said communication processor uses said predicted information in communicating said medical information to said second healthcare facility.

4. A system according to claim 1, including
a transformation processor for transforming medical information of said individual patient in a first format into said common format.

5. A system according to claim 1, including
an audit processor for recording information identifying two or more of, (a) a destination of said communicated medical information of said individual patient, (b) a user authorizing or initiating communication of said medical information of said individual patient and (c) a workstation used for authorizing communication of said medical information of said individual patient.

6. A system according to claim 1, including
an acquisition processor for automatically acquiring medical information of said individual patient from a remote system for formatting into said common format.

7. A system according to claim 1, including
a query generator for automatically generating messages for communication to remote systems to request from said remote systems, medical information of said individual patient for formatting into said common format, in response to occurrence of an event detected by said monitor.

8. A system according to claim 1, including
a query generator for automatically generating messages for communication to remote systems to request said remote systems communicate medical information of said individual patient to said second healthcare facility in said common format, in response to occurrence of an event detected by said monitor.

9. A system according to claim 1, including
said determination said event occurs comprises detection of data indicating said individual patient is at least one of, (a) scheduled to receive healthcare services at said second healthcare facility, (b) scheduled for an appointment at said second healthcare facility, (c) admitted to said second healthcare facility and (d) transferred to said second healthcare facility.

10. A system according to claim 1, including
said determination said event occurs comprises detection of data indicating said individual patient is in an emergency department and including
a prediction processor for predicting information comprising an identity and location of said second healthcare facility where said individual patient is to receive further healthcare.

11. A system according to claim 10, wherein
said prediction processor predicts identity and location of said second healthcare facility in response to at least one of, (a) a patient diagnosis, (b) a patient medical condition assessment, (c) data indicating a current healthcare treatment being received by said individual patient and (d) data indicating a current location where healthcare treatment is being received by said individual patient.

12. A system according to claim 1, including
said monitor monitors activities of an individual patient selected in response to user entered patient identification information.

13. A system according to claim 12, including
said user entered patient identification information includes at least one of, (a) social security number, (b) name, (c) medical record number, (d) patient identifier, (e) encounter or account number, (f) birth date and (g) a government issued patient identification number.

14. A system according to claim 1, wherein
said communication processor communicates said medical information of said individual patient to said second healthcare facility at a destination identified using user entered information.

15. A system for acquiring patient medical information from different healthcare facilities, comprising:
an interface of a second healthcare facility for receiving medical information of an individual patient in a common format from a first healthcare facility, said common format being employed by said different healthcare facilities for exchanging patient medical information in response to occurrence of an event detected by monitoring activities of individual patients to determine if an event occurs indicating an individual patient is likely to receive services at another healthcare facility; and
a transformation processor for transforming said received medical information of said individual patient in said common format to a different format for use by said second healthcare facility.

16. A system according to claim 15, including
a storage processor for storing said transformed medical information of said individual patient in a record associated with said individual patient identified using patient identification information derived from said received medical information of said individual patient.

17. A system according to claim 15, including
a configuration processor enabling a user to designate said second healthcare facility is to receive medical information of said individual patient in said common format from said different healthcare facilities in messages communicated from said different healthcare facilities in response to a detected change in said medical information of said individual patient.
